(19) United States
(12) Patent Application Publication
(10) Pub. No.: US 2025/0218168 A1
(43) Pub. Date: Jul. 3, 2025

(54) PERFORMING COMPUTER VISION TASKS BY GENERATING SEQUENCES OF TOKENS

(71) Applicant: Google LLC, Mountain View, CA (US)

(72) Inventors: Ting Chen, Mountain View, CA (US); David James Fleet, Toronto (CA); Geoffrey E. Hinton, Toronto (CA); Yi Li, Oakville (CA); Saurabh Saxena, Mississauga (CA); Tsung-Yi Lin, Sunnyvale, CA (US)

(21) Appl. No.: 18/867,142

(22) PCT Filed: May 19, 2023
(86) PCT No.: PCT/US2023/022957

§ 371 Date: Nov. 19, 2024

Related U.S. Application Data
(60) Provisional application No. 63/344,018, filed on May 19, 2022.

(51) Int. Cl. G06V 10/82; G06F 40/284; G06V 10/25; G06V 10/96

(52) U.S. Cl. CPC G06V 10/82; G06F 40/284; G06V 10/25; G06V 10/96

(57) ABSTRACT

Methods, systems, and apparatus, including computer programs encoded on computer storage media, for performing multiple computer vision tasks using a shared computer vision neural network. In one aspect, one of the methods includes obtaining an input image; processing the input image and a prompt sequence using a shared computer vision neural network to generate an output sequence that comprises respective token at each of a plurality of time steps, wherein each token is selected from a shared vocabulary of tokens that is shared between the plurality of computer vision tasks, wherein the shared vocabulary comprises (i) a first set of tokens that each represent a respective discrete number from a set of discretized numbers and (ii) a second set of tokens that each represent a natural language text token.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that uses a shared computer vision neural network to perform any of multiple computer vision tasks.

The subject matter described in this specification can be implemented in particular embodiments so as to realize one or more of the following advantages.

Conventionally, the inputs and outputs of various computer vision tasks have been represented with very different output spaces and, sometimes, different input spaces. As a result, there is a proliferation of distinct architectures and loss functions for different vision tasks.

Using the described techniques, on the other hand, a single, shared computer vision neural network can be used to perform multiple different computer vision tasks. In particular, by representing the outputs of each task as tokenized sequences, the shared computer vision neural network can be used to perform tasks with different output spaces. Thus, the described systems consume significantly less memory than other, single-task approaches while providing significantly better accuracy across the multiple tasks than other multi-task approaches. That is, by formulating the output of each task as a sequence of discrete tokens with a unified interface, a neural network with a single model architecture and loss function can be simultaneously trained on all these tasks, with no task-specific customization, while still achieving comparable or better performance on the multiple tasks than specialized architectures.

Thus, relative to systems that require a separate neural network for each of the multiple tasks, the described system consumes significantly less memory when deployed for performing the multiple tasks. That is, the described system requires storing only a single set of network parameters of the shared computer vision neural network, rather than multiple sets of network parameters for multiple different task-specific computer vision neural networks. The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a diagram of an example multi-task computer vision system.

FIG. 2 is a flow diagram of an example process for performing a computer vision task.

FIG. 3 is a diagram that shows examples of task outputs generated using the shared computer vision neural network.

FIG. 4 is a diagram that shows the training of the shared computer vision neural network.

Like reference numbers and designations in the various drawings indicate like elements.

### DETAILED DESCRIPTION

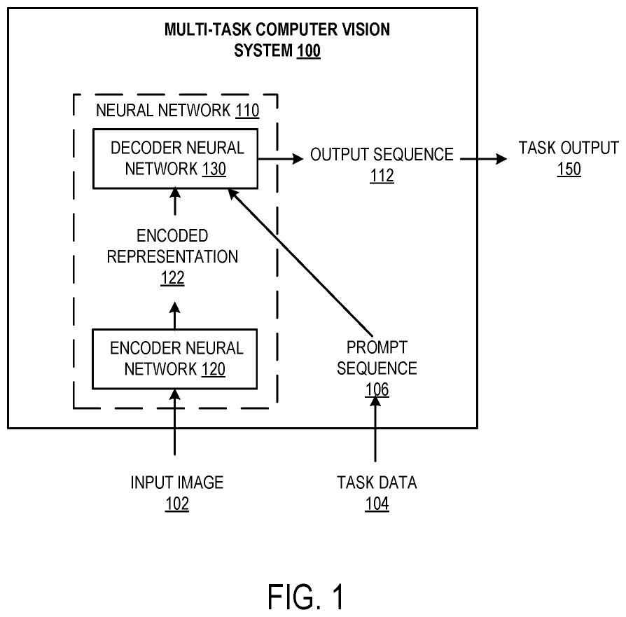

FIG. 1 is a diagram of an example multi-task computer vision system 100. The multi-task computer vision system 100 is an example of a system implemented as computer programs on one or more computers in one or more locations, in which the systems, components, and techniques described below can be implemented.

The multi-task computer vision system 100 is a system that receives an input image 102 and generates a task output 150 for a computer vision task by processing the image 102 using a shared computer vision neural network 110 to generate the task output 150 for the input image 102.

The system 100 is referred to as a “multi-task” computer vision system 100 because the system 100 is configured to perform any of multiple computer vision tasks.

Similarly, the shared computer vision neural network 110 is referred to as “shared” because the system uses the same computer vision neural network 110 to perform all of the multiple tasks.

The system can be configured to perform two or more of a variety of computer vision tasks. Generally, a computer vision task is a task that requires processing an image, i.e., processing the intensity values of the pixels of the image, to generate a prediction that characterizes the image.

Some non-limiting examples of computer vision tasks that the system 100 can be configured to perform now follow.

In some examples, the computer vision tasks include one or more tasks that require making predictions that characterize objects depicted in the input image. For example, the computer vision tasks can include one or more of: object detection; object keypoint detection; object localization; object instance segmentation; and/or object description (captioning) of one or more objects depicted in the input image.

As one example, one of the tasks can be object detection. For an object detection task, the output 150 identifies one or more bounding boxes in the input image 102 that each correspond to a detected object, i.e., are predicted to contain a depiction of the detected object and, for each of the bounding boxes, an object category from a set of object categories to which the detected object in the bounding box belongs.

As another example, one of the tasks can be a keypoint detection task. For keypoint detection, the output 150 specifies coordinates of one or more keypoints on one or more objects depicted in the input image 102.

As yet another example, one of the tasks can be an image captioning task. For image captioning, the output 150 is a sequence of text that captions the input image 102, i.e., a text caption that describes the content of the input image 102.

As yet another example, one of the tasks can be an instance segmentation task. For instance segmentation, the output 150 identifies, for one or more objects in the input image, instances of the object within the input image 102. That is, the instance segmentation output identifies which pixels in the image belong to each of one or more instances of the object that are depicted in the input image.

More specifically, the system 100 obtains an input image 102 and task data 104 specifying a target computer vision task from the multiple computer vision tasks to be performed on the input image 102.

The system generates, from the task data 104 a prompt sequence 106 describing the target computer vision task, i.e., describing the computer vision task specified by the task data 104.

The system 100 processes the input image 102, i.e., processes the intensity values of the pixels of the input image 102, and the prompt sequence 106 using the shared computer vision neural network 110 to generate an output sequence 112 that includes a plurality of tokens.

Each token is selected from a shared vocabulary of tokens that is shared between the plurality of computer vision tasks. The shared vocabulary includes (i) a first set of tokens that each represent a respective discrete number from a set of discretized numbers, i.e., a set of numbers that can be mapped to quantized image coordinates in the input image, and (ii) a second set of tokens that each represent a natural language text token. The natural language text tokens can include (i) category labels for a set of object categories and (ii) other natural language text tokens that can be used to generate natural language text, e.g., tokens representing any of: words, characters, sub-words or word pieces, punctuation marks, separator characters, and so on.

Generally, so that the prompt sequence 106 can be processed by the shared computer vision neural network 110, the prompt sequence 106 is also made up of tokens that are selected from the shared vocabulary. The prompt sequence 106 can include a natural language description of the task and, optionally, can specify one or more parameters required to perform the task, e.g., a bounding box that represents a portion of the image on which the task is to be performed.

The tokens in the vocabulary can be represented in any appropriate way, e.g., as integers or other alphanumeric symbols that are distinguishable from one another.

More specifically, the system discretizes the numbers used to represent the coordinates of any given point in the input image 102 into multiple bins, with each of the bins corresponding to a respective one of the tokens in the first set of tokens. As a particular example, the system can discretize the range of values between zero and the height or width of the image in pixels into a fixed number of evenly spaced bins, so that each bin corresponds to a different subset of the pixel indices that can be used to represent the coordinates of a point (in pixels) within the image. Thus, if the input images are 600 pixels×600 pixels and there are 600 bins, each bin will correspond to a different pixel index from 1 to 600. If the input images are 600×600 and there are 300 bins, each bin will correspond to a different set of two pixel indices from 1 to 600.

Thus, each token in the first set of tokens represents a different bin in a discretization of the possible coordinate values for a pixel in the image and can be mapped to a different quantized coordinate value, e.g., a representative value for the bin represented by the token. For example, the representative value can be the average of the end points of the bin or one of the two end points of the bin. This quantization scheme of the coordinates allows the system to use a relatively small vocabulary to represent possible pixel coordinates while maintaining high precision.

Thus, as a particular example, when there are 600 bins in the quantization scheme and tokens are represented as integers, the vocabulary can include tokens 1-600 that represent the 600 possible quantized coordinates and tokens 601 and up that represent the natural language text tokens.

Optionally, as will be described in more detail, the vocabulary can also include one or more additional tokens in addition to those described above.

Generally, the shared computer vision neural network 110 is configured to generate the output sequence across multiple time steps.

At each time step, the neural network 110 is configured to generate a score distribution over the tokens in the vocabulary for each time step conditioned on (i) the input image and (ii) the tokens at any earlier time steps in the output sequence.

Thus, at each time step during the generation of the output sequence 112, the system 100 selects the respective token at the time step in the output sequence 112 using the respective score distribution generated by the shared computer vision neural network 110 for the time step.

As one example, the system 100 can greedily select the highest scoring token.

As another example, the system 100 can select the respective token by sampling a token in accordance with the score distribution. As a particular example, the system can sample a token in accordance with the score distribution using nucleus sampling.

As a particular example, the shared computer vision neural network 110 can include an encoder neural network 120 and a decoder neural network 130.

The encoder neural network 120 can be configured to process the input image 102 to generate an encoded representation 122 of the input image 102. The encoded representation 122 is a sequence that includes a plurality of encoded vectors that collectively represents the input image 102.

The encoder neural network 120 can be any appropriate image encoder neural network that receives the intensity values of the pixels of the image 102 and encodes them into hidden representations. Examples of such encoders include convolutional neural networks, Transformer neural network, or neural networks that include both convolutional layers and self-attention layers. An example of a convolutional neural network that can be used as the encoder is described in Kaiming He, Xiangyu Zhang, Shaoqing Ren, and Jian Sun. Deep residual learning for image recognition. In Proceedings of the IEEE Conference on Computer Vision and Pattern Recognition, pp. 770-778, 2016. An example of a Transformer neural network that can be used as the encoder is described in Alexey Dosovitskiy. Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al. An image is worth 16×16 words: Transformers for image recognition at scale. In International Conference on Learning Representations, 2020. An example of a neural network that includes both convolutional layers and self-attention layers that can be used as the encoder is described in Nicolas Carion, Francisco Massa, Gabriel Synnaeve, Nicolas Usunier, Alexander Kirillov, and Sergey Zagoruyko. End-to-end object detection with transformers. In European Conference on Computer Vision, pp. 213-229. Springer, 2020.

When the last layer of the encoder 120 is a convolutional layer that generates a feature map, the system 100 can generate the encoded representation 122 by flattening the feature map into a sequence of vectors. When the last layer of the encoder 120 is an attention layer, the system 100 can directly use the outputs of the attention layer as the encoded representation 122.

The decoder neural network 130 is configured to process the encoded representation 122 of the input image 102 and the prompt sequence 106 to generate the output sequence 112

In particular, the decoder 130 can be an auto-regressive decoder neural network that, at each time step, processes the prompt sequence 106 followed by any tokens at any earlier time steps in the output sequence 112 while conditioned on the encoded representation 122 of the input image 102 to generate a respective score distribution for the time step. The score distribution includes a respective score, e.g., a probability or a logit, for each token in the vocabulary.

As a particular example, the decoder 130 can be a Transformer decoder that applies causal self-attention over the prompt sequence 106 and the already generated tokens and cross-attention into the encoded representation 122. That is, the decoder 130 can include both self-attention layers that apply causal self-attention over representations of the prompt sequence and already generated tokens and cross-attention layers that cross-attend into the encoded representation 122.

Examples of such Transformer decoders that can be used as the decoder 130 are described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer, arXiv preprint arXiv:1910.10683, 2019 and Alec Radford, Karthik Narasimhan, Tim Salimans, and Ilya Sutskever. Improving language understanding by generative pre-training. 2018.

The system 100 then generates, from the tokens in the output sequence 112, the task output 150 for the target computer vision task. That is, the output for each of the tasks can be represented by a sequence of tokens in the shared vocabulary. For a given task, the system 100 maps the tokens in the output sequence 112 to an output for the task in accordance with a pre-determined syntax for the task.

As a particular example, for object detection, the system 100 maps the tokens in the output sequence 112 to data identifying one or more bounding boxes in the input image and, for each bounding box, a respective object category from the set of object categories to which an object depicted within the bounding box belongs.

For each bounding box, the data identifying the bounding box specifies the position of the bounding box within the image. As one example, the data identifying the bounding box can specify the coordinates of two or more of the corners of the bounding box. As another example, the data identifying the bounding box can specify the coordinates of the center of the bounding box and the height and width of the bounding box.

Examples of syntaxes and mappings for various computer vision tasks are described in more detail below.

Thus, the shared computer vision neural network 110 generates an output sequence 112 of discrete tokens that can be directly mapped to an output for a computer vision task by the system 100. The neural network 110 generates outputs for different ones of the tasks by virtue of being conditioned on different prompt sequences 106. By generating the task output in this manner, the system 100 does not need to be highly customized or use neural networks with complex architectures and can be readily integrated into a larger system. Moreover, by generating the task output, the system 100 generates a unified interface that allows the same model to be used for all of the multiple tasks without needing to customize the architecture for any one of the tasks.

As a particular example, the system 100 can be part of a perception system embedded within an agent, e.g., a robot or an autonomous vehicle, that processes images and optionally other sensor data collected by sensors of the agent and the task output can be used by the perception system or other software on-board the agent to control the agent as the agent navigates through the environment.

As another particular example, the system 100 can be part of a perception system embedded within or in communication with a different type of device that processes sensor data, e.g., a camera monitoring system, a mobile phone, and so on. The task outputs generated by the system 100 can be used as part of a pre-processing stage before images are displayed to a user or can be used to automatically trigger other actions.

As yet another particular example, client devices can interact with the system 100 through an application programming inference (API), e.g., a web-based API. In particular. client devices can submit an API call that includes or identifies an image to be analyzed and the task or tasks to be performed on the image. The system 100 can provide, in response, data identifying the task output. For example, the system 100 can format the task output in a specified format, e.g., as a JavaScript Object Notation (JSON) file or as a file in another type of data-interchange format, and provide the file in response to the API call.

Prior to using the neural network 110 to perform these tasks, the system 100 or another training system trains the neural network 110 on training data that includes multiple training examples.

Each training example includes an input training image and a ground truth output for the image for one or more of the computer vision tasks.

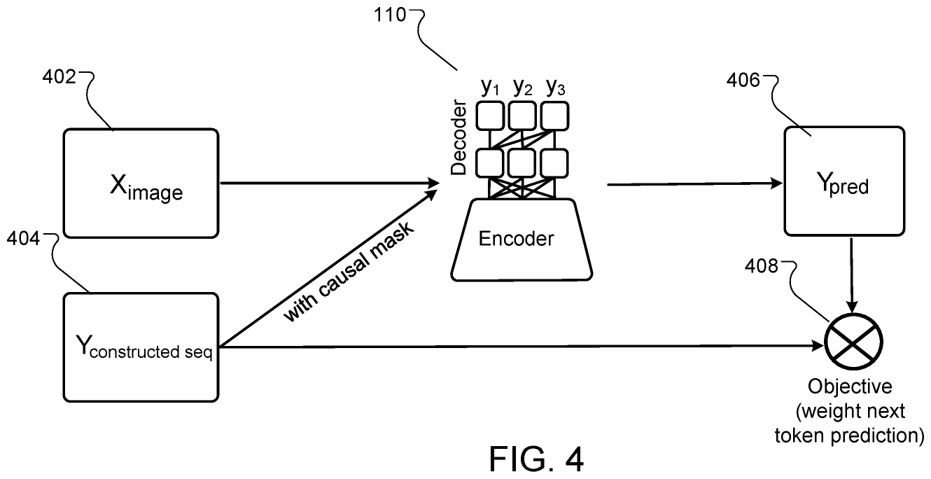

Training the neural network 110 will be described in more detail below with reference to FIG. 4.

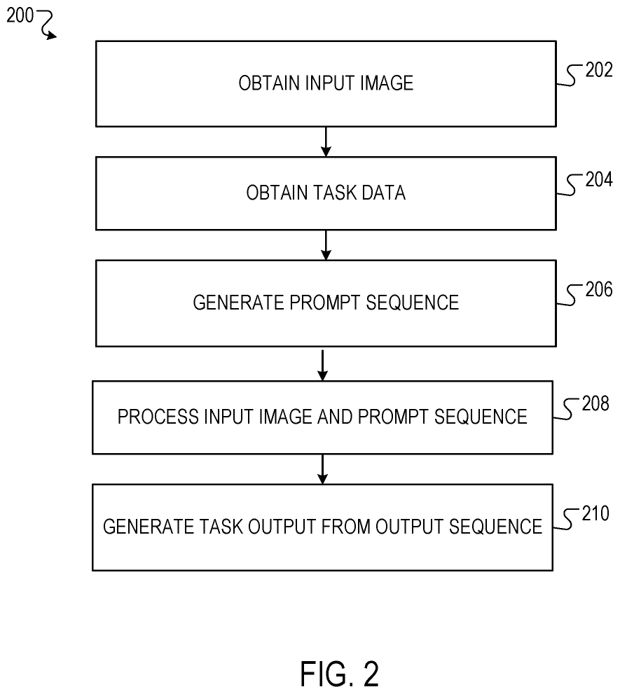

FIG. 2 is a flow diagram of an example process 200 for generating a task output for an input image. For convenience, the process 200 will be described as being performed by a system of one or more computers located in one or more locations. For example, an multi-task computer vision system, e.g., the multi-task computer vision system 100 depicted in FIG. 1, appropriately programmed in accordance with this specification, can perform the process 200.

The system obtains an input image (step 202).

The system obtains data specifying a target computer vision task from a plurality of computer vision tasks to be performed on the input image (step 204).

The system generates a prompt sequence describing the target computer vision task (step 206).

Generally, the system generates a prompt sequence that includes tokens from the shared vocabulary and that identifies the target task to the computer vision neural network.

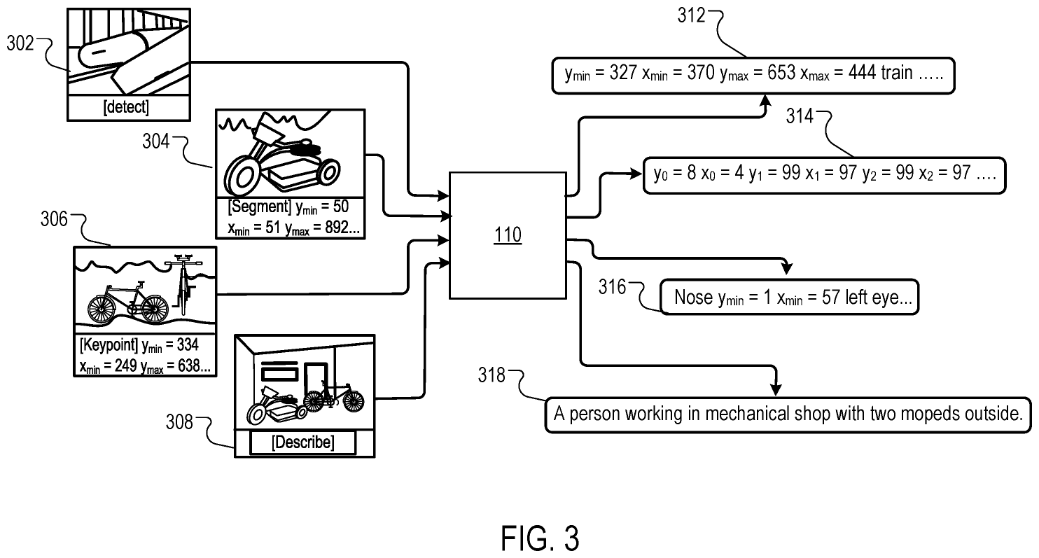

Examples of prompt sequences for various tasks will be described below with reference to FIG. 3.

The system processes the input image and the prompt sequence using a shared computer vision neural network to generate an output sequence (step 208).

As described above, the output sequence includes a respective token at each of a plurality of time steps. Each token is selected from a shared vocabulary of tokens that is shared between the plurality of computer vision tasks. The shared vocabulary includes (i) a first set of tokens that each represent a respective discrete number from a set of discretized numbers, i.e., a set of numbers that can be mapped to quantized image coordinates in the input image, and (ii) a second set of tokens that each represent a natural language text token.

The vocabulary can also optionally include additional tokens.

For example, the vocabulary can include an end-of-sequence (EOS) token.

Generally, as described above, the shared computer vision neural network is configured to generate the output sequence across multiple time steps.

At each time step, the neural network is configured to generate a score distribution over the tokens in the vocabulary for each time step conditioned on (i) the input image, (ii) the prompt sequence, and (ii) the tokens at any earlier time steps in the output sequence.

Thus, at each time step during the generation of the output sequence, the system selects the respective token at the time step in the output sequence using the respective score distribution generated by the shared computer vision neural network for the time step.

As one example, the system can greedily select the highest scoring token.

As another example, the system can select the respective token by sampling a token in accordance with the score distribution. As a particular example, the system can sample a token in accordance with the score distribution using nucleus sampling.

In some implementations, the system continues adding tokens to the output sequence until the end of sequence (EOS) token is selected. In some other implementations, the system continues adding tokens to the output sequence until the output sequence has a fixed length, i.e., has a maximum number of tokens. In yet other implementations, the system continues adding tokens to the output sequence until the EOS token has been selected or until the output sequence has the fixed length, whichever occurs first.

The system generates, from the tokens in the output sequence, a task output for the machine learning task (step 206).

In particular, because of the way that the neural network is trained, the output sequence will conform to the syntax for the target computer vision task due to the prompt sequence being provided as input to the neural network.

As a particular example, for object detection, the task output requires data identifying one or more bounding boxes in the input image and, for each bounding box, a respective object category from the set of object categories to which an object depicted in the bounding box belongs.

When the target computer vision task is object detection, the output sequence includes a respective subsequence for each of one or more bounding boxes in the input image.

The subsequence for a given bounding box includes tokens from the first set of tokens and a token from the second set of tokens. For example, the subsequence can include five total tokens: four tokens from the first set and one token from the second set. As a particular example, the subsequence can include four tokens from the first set followed by one token from the second set.

In some cases, the four discrete numbers that are represented by the four tokens from the first set specify coordinates in the input image of two corners of the bounding box, e.g., the (x, y) coordinates of the upper left corner and the lower right corner or of the lower right corner and the upper left corner.

In some other cases, the four discrete numbers that are represented by the four tokens from the first set specify coordinates in the input image of the center of the bounding box and the height and width of the bounding box.

Thus, to generate the object detection output, the system can identify, for each subsequence in the output sequence, and from the tokens in the subsequence that belong to the first set of tokens, coordinates of the bounding box in the input image and then identify, as the respective object category to which the object depicted in the bounding box belongs, the object category represented by a token in the corresponding subsequence that belongs to the second set of tokens.

In other words, for each first token in the subsequence, the system can map the first token to the quantized coordinate value represented by the token to generate the coordinates that define the bounding box and, for each second token, the system can map the token to the label or other data that identifies the object category represented by the second token.

In some implementations, the system also associates the respective score assigned to the token that represents the respective object category for the bounding box in the score distribution at the corresponding time step with the bounding box to represent a confidence that the respective object category is a correct category for the object.

In some implementations, the system can refrain from including, in the object detection output, one or more bounding boxes, e.g., if the confidence score for the corresponding object category is below a threshold value.

When the task is a keypoint prediction task, the prompt sequence identifies an object instance in the input image, i.e., identifies the object on the surface of which keypoints should be identified.

The output sequence includes a respective subsequence of quantized image coordinate values for each of one or more keypoints that specify a position of the keypoint in the input image. That is, the subsequence includes two tokens from the first set for each of one or more keypoints, with the two tokens representing the (x, y) coordinate of the keypoint in the input image. The system can then map the two tokens to generate a dequantized (x, y) coordinate for the keypoint.

When the task is image captioning, the output sequence is a sequence of tokens from the second set of tokens that represent a text caption for the input image. For this task, the system can directly generate a text sequence from the sequence of tokens and output the text sequence as the task output, i.e., the text caption for the input image.

When the task is instance segmentation, the prompt sequence will identify an instance of an object. For this task, the output sequence is a sequence of tokens from the first set of tokens that represent quantized coordinates of a polygon overlaid over the object instance in the input image. The system can then parse the sequence of tokens to map the quantized coordinates to image coordinates and then generate a dense mask over the image that specifies the pixels that belong to the object instance, i.e., so that pixels within the polygon are identified as belonging to the object instance while pixels outside the polygon are identified as not belonging to the object instance.

In some cases, for the instance segmentation task, to improve performance, the system can generate one or more additional output sequences conditioned on the same prompt sequence in order to generate a respective dense mask for each of the additional output sequences. The system can then average the dense masks for the additional output sequence and the dense mask for the original output sequence to generate a final dense mask that is used to generate the final task output. For example, the system can apply a threshold to the averaged mask to obtain a single binary mask and use the binary mask as the task output.

The system can then output data identifying the task output.

As a particular example, when the system is part of a perception system embedded within an agent, e.g., a robot or an autonomous vehicle, that processes images and optionally other sensor data collected by sensors of the agent the system can provide the data identifying the task output to the perception system or other software on-board the agent to control the agent as the agent navigates through the environment.

As another particular example, when the system is part of a perception system embedded within or in communication with a different type of device that processes sensor data, e.g., a camera monitoring system, a mobile phone, and so on, the system can output the data to another software component of the device for use in pre-processing the image before the image is displayed to a user or for use in automatically triggering an action, e.g., an alert.

As yet another particular example, when client devices can interact with the system through an application programming inference (API), e.g., a web-based API, the system can provide, in response to an API call, data identifying the task output. For example, the system can format the object detection output in a specified format, e.g., as a JavaScript Object Notation (JSON) file or as a file in another type of data-interchange format, and provide the file in response to the API call.

FIG. 3 shows example task outputs that were extracted from output sequences generated by the shared computer vision neural network.

In particular, FIG. 3 shows portions of example task outputs for four example input images 302, 304, 306, and 308.

As can be seen from FIG. 3, the system processes each of the input images 302, 304, 306, and 308 using the neural network 110 along with a corresponding prompt sequence to generate a respective output sequence and then extracts the corresponding task output portion 312, 314, 316, and 318 for the task specified by the corresponding prompt sequence from the output sequence for the input image.

Generally, the prompt sequence for each computer vision task includes one or more tokens that uniquely identify the computer vision task, i.e., that are different for each computer vision task. For example, these tokens can be a natural language description of the task.

As can be seen from FIG. 3, the prompt for the object detection task, i.e., the task that is performed on the input image 302 includes a natural language phrase identifying the task, e.g., “[detect]”.

In the example of FIG. 3, the object detection output portion 312 for the image 302 specifies that the bounding box has a lower right corner at y_min=327 and x_min=370 (in pixel coordinates), an upper right corner at y_max=653 and x_max=44, and is an image of an object that belongs to the “train” category.

For example, when the tokens are represented as integers, images are 400×400, and each first token corresponds to one pixel of the image, the system can extract the objection detection output portion from the subsequence [327, 370, 653, 44, 415], where “415” is the token that represents the “train” category. That, is while the portion 312 is shown as including identifying information for each element, the underlying output sequence is only a sequence of discrete tokens from the vocabulary. Alternatively, the vocabulary can include one or more text tokens that represent the “train” category, e.g., words, word pieces, or characters, i.e., instead of an integer that can be mapped to a category identifier.

As can be seen from FIG. 3, the prompt for the instance segmentation task, i.e., the task that is performed on the input image 304, includes a natural language phrase identifying the task, e.g., “[Segment]” and quantized coordinates of the bounding box that contains the object to be segmented. As with the portion 312, while the prompt is shown as including identifying information for each element, the underlying prompt sequence can include only a sequence of discrete tokens from the vocabulary.

In the example of FIG. 3, the segmentation output portion 314 for the image 304 specifies quantized coordinates of the vertices of a polygon overlaid over the image 304. By making use of the EOS token, the neural network 110 can generate sequences of coordinates that represent varying numbers of vertices in order to segment arbitrarily shaped objects.

As can be seen from FIG. 3, the prompt for the keypoint identification task, i.e., the task that is performed on the input image 306, includes a natural language phrase identifying the task, e.g., “[Keypoint]” and quantized coordinates of the bounding box that contains the agent with keypoints to be identified. As with the portion 312, while the prompt is shown as including identifying information for each element, the underlying prompt sequence can include only a sequence of discrete tokens from the vocabulary.

In the example of FIG. 3, the keypoint output portion 316 for the image 316 specifies quantized coordinates of the keypoints of the agent in the image 306. By making use of the EOS token, the neural network 110 can generate sequences of coordinates that represent varying numbers of keypoints.

As can be seen from FIG. 3, the prompt for the captioning task, i.e., the task that is performed on the input image 308 includes a natural language phrase identifying the task, e.g., “[Describe]”.

In the example of FIG. 3, the captioning output portion 318 for the image 308 represents a natural language text sequence that describes the content of the image 308 (i.e., “A person working in mechanical shop with two mopeds outside”). For example the neural network 318 can generate an output of tokens that represent word pieces that can be directly mapped to the natural language text sequence.

Thus, as can be seen from FIG. 3, by modifying the prompt sequence, the neural network 110 can be used to perform multiple different computer vision tasks that all have outputs that can be represented as differently formatted output sequences, i.e., output sequences arranged according to different syntaxes.

FIG. 4 is a diagram 400 that illustrates the training of the neural network 110.

As described above, prior to using the neural network 110 to perform multiple tasks, the system 100 or another training system trains the neural network 110 on training data that includes multiple training examples.

Each training example includes an input training image 402 and a ground truth output for the image for one or more of the computer vision tasks.

In particular, the system can repeatedly perform iterations of a training process on different batches of training examples to train the neural network, i.e., to repeatedly adjust the values of the parameters of the neural network. That is, at each iteration of the training process, the system obtains a batch of one or more training examples, e.g., by sampling the batch from a larger set of training data, and then performs an iteration of the training process to update the current values of the network parameters as of the iteration.

For example, the system can continue to perform iterations of the training process until a termination criterion has been satisfied, e.g., until a threshold number of training iterations have been performed, until a specified amount of time has elapsed, or until the parameters have been determined to converge.

At each iteration of the training process, the system obtains a batch of training examples. Each training example includes a training image 402 and a target output for one of the computer vision tasks. In some implementations, the batch includes only training examples for one of the tasks while, in other implementations, the batch can include training examples for multiple ones of the tasks.

In some implementations, the system applies one or more augmentation techniques to generate the batch from an initial batch of training examples.

As one example, the system can generate one or more of the training images in the batch by applying one or more image augmentation policies to a corresponding initial training image. The system can then associate each generated training image with the target output for the corresponding initial training image. Applying the image augmentation policies can improve the robustness of the trained neural network to various image perturbations that may not be well represented in the training data.

For example, the image augmentation policies can specify how to apply random scaling, crops, or other image augmentation techniques to the initial training images to generate the batch of training examples.

As one example, the system can perform scale jittering with random crops on the initial training images. An example of such a technique is described in Golnaz Ghiasi, Yin Cui, Aravind Srinivas, Rui Qian, Tsung-Yi Lin, Ekin D Cubuk, Quoc V Le, and Barret Zoph. Simple copy-paste is a strong data augmentation method for instance segmentation. In Proceedings of the IEEE/CVF Conference on Computer Vision and Pattern Recognition, pp. 2918-2928, 2021.

As another example, the system can perform image scaling by resizing images (with a fixed aspect ratio) so that the longer side has a fixed number of pixels.

As another example, the system can apply color distortion to the intensity values of pixels in the initial training images. An example of such a technique is described in Andrew G Howard. Some improvements on deep convolutional neural network based image classification, arXiv preprint arXiv:1312.5402, 2013.

Instead of or in addition to the image augmentations, the system can also apply augmentations to the target outputs in the training examples to improve the robustness of the trained model to noisy predictions or mis-labeled training data, e.g., by injecting noise into the target outputs.

For each training image X_{image} 402, the system generates a target output sequence Y_{constructed} 404 that describes the ground truth target output in the syntax for the corresponding computer vision task. The target output sequence 404 also includes the prompt sequence for the corresponding task.

The system then trains the shared computer vision neural network 110 to maximize, for each training image and for each token in at least a subset of the tokens in the target output sequence for the training image, a log likelihood of the token conditioned on any preceding tokens in the target output sequence and the training image.

In order to train the neural network to maximize the log likelihoods, the system computes, through backpropagation, gradients of an objective function 408 that measures the log likelihoods of the at least the subset of the tokens with respect to the parameters of the encoder neural network and the decoder neural network and then updates the parameters using the determined gradients. For example, the system can apply an appropriate optimizer, e.g., the Adam optimizer, the rmsProp optimizer, the Adafactor optimizer, or a different machine learning optimizer, to the gradient and the parameters to update the parameters. For example, the loss function can be the average of, for each training example, a combination of, e.g., a sum or a weighted sum of, the log likelihoods for the training output sequence in the training example. In other words, the objective 408 can be a weighted next token prediction objective, with the weight for the prompt tokens in the prompt sequence being set to zero. For example, the system can process Y_{constructed} 404 using the neural network 110 using teacher forcing to get the likelihoods Y_{pred} 406 that are used to compute the log likelihood.

In some implementations, rather than process a single batch at each training iteration. the system instead processes multiple batches, each batch corresponding to a different one of the multiple tasks. The system can then aggregate their gradients, e.g., using an average or a weighted average, and then apply the optimizer to the aggregated gradient as described above.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data; the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining an input image;
obtaining data specifying a target computer vision task from a plurality of computer vision tasks to be performed on the input image;
generating a prompt sequence describing the target computer vision task;
processing the input image and the prompt sequence using a shared computer vision neural network that is shared between the plurality of computer vision tasks to generate an output sequence that comprises a respective token at each of a plurality of time steps, wherein each token is selected from a shared vocabulary of tokens that is shared between the plurality of computer vision tasks, wherein the shared vocabulary comprises (i) a first set of tokens that each represent a respective discrete number from a set of discretized numbers and (ii) a second set of tokens that each represent a natural language text token; and
generating, from the tokens in the output sequence, an output for the target computer vision task.

2. The method of claim 1, wherein the shared computer vision neural network comprises:
an encoder neural network configured to process the input image to generate an encoded representation of the input image, and
an auto-regressive decoder neural network configured to auto-regressively generate the output sequence conditioned on the encoded representation of the input image and the prompt sequence.

3. The method of claim 2, wherein the prompt sequence is a sequence of tokens from the shared vocabulary, and wherein the auto-regressive decoder neural network is configured to, at each time step:
process an input sequence comprising (i) the prompt sequence and (ii) any tokens at any earlier time steps in the output sequence to generate a probability distribution over the tokens in the vocabulary.

4. The method of claim 2, wherein the auto-regressive decoder neural network is an auto-regressive self-attention decoder neural network.

5. The method of claim 1, wherein the encoder neural network is a Vision Transformer, a convolutional neural network, or a neural network that includes both convolutional neural network layers and self-attention layers.

6. The method of claim 1, wherein the computer vision task is object detection and wherein generating, from the tokens in the output sequence, an output for the target computer vision task comprises generating, from the tokens in the output sequence, data identifying one or more bounding boxes in the input image and, for each bounding box, a respective object category from the set of object categories to which an object depicted in the bounding box belongs.

7. The method of claim 6, wherein the output sequence comprises a respective subsequence corresponding to each of the one or more bounding boxes, and wherein generating the data identifying the one or more bounding boxes comprises, for each bounding box:
identifying, from tokens in the corresponding subsequence that belong to the first set of tokens, coordinates of the bounding box in the input image; and
identifying, as the respective object category to which the object depicted in the bounding box belongs, the object category represented by a set of one or more tokens belonging to the second set of tokens.

8. The method of claim 7, wherein the respective subsequence includes four tokens from the first set of tokens and wherein the four discrete numbers that are represented by the four tokens specify coordinates in the input image of two corners of the bounding box.

9. The method of claim 7, wherein the respective subsequence includes four tokens from the first set of tokens and wherein the four discrete numbers that are represented by the four tokens specify coordinates in the input image of a center of the bounding box and a height and width of the bounding box.

10. The method of claim 7, further comprising generating a confidence score for the object from respective scores assigned by the neural network to the set of one or more tokens.

11. The method of claim 1, wherein the computer vision task is a keypoint prediction task, wherein the prompt sequence identifies an object instance in the input image, and wherein the output sequence includes a respective subsequence of quantized image coordinate values for each of one or more keypoints that specify a position of the keypoint in the input image.

12. The method of claim 11, wherein the respective subsequence for each keypoint comprises a set of tokens from the second set of tokens that represent a description of the keypoint.

13. The method of claim 1, wherein the computer vision task is image captioning and wherein the output sequence is a sequence of tokens from the second set of tokens that represent a text caption for the input image.

14. The method of claim 1, wherein the computer vision task is instance segmentation, wherein the prompt sequence identifies an instance of an object, and wherein the output sequence is a sequence of tokens from the first set of tokens that represent quantized coordinates of a polygon overlaid over the object instance in the input image.

15. The method of claim 14, further comprising: generating one or more additional output sequences conditioned on the same prompt sequence, and generating a final instance segmentation output comprising averaging dense masks generated from each of the output sequences.

16. A system comprising:
one or more computers; and
one or more storage devices storing instructions that, when executed by the one or more computers, cause the one or more computers to perform operations comprising:
obtaining an input image;
obtaining data specifying a target computer vision task from a plurality of computer vision tasks to be performed on the input image;
generating a prompt sequence describing the target computer vision task;
processing the input image and the prompt sequence using a shared computer vision neural network that is shared between the plurality of computer vision tasks to generate an output sequence that comprises a respective token at each of a plurality of time steps, wherein each token is selected from a shared vocabulary of tokens that is shared between the plurality of computer vision tasks, wherein the shared vocabulary comprises (i) a first set of tokens that each represent a respective discrete number from a set of discretized numbers and (ii) a second set of tokens that each represent a natural language text token; and
generating, from the tokens in the output sequence, an output for the target computer vision task.

17. One or more non-transitory computer-readable storage media storing instructions that when executed by one or more computers cause the one or more computers to perform operations comprising:
obtaining an input image;
obtaining data specifying a target computer vision task from a plurality of computer vision tasks to be performed on the input image;
generating a prompt sequence describing the target computer vision task;
processing the input image and the prompt sequence using a shared computer vision neural network that is shared between the plurality of computer vision tasks to generate an output sequence that comprises a respective token at each of a plurality of time steps, wherein each token is selected from a shared vocabulary of tokens that is shared between the plurality of computer vision tasks, wherein the shared vocabulary comprises (i) a first set of tokens that each represent a respective discrete number from a set of discretized numbers and (ii) a second set of tokens that each represent a natural language text token; and
generating, from the tokens in the output sequence, an output for the target computer vision task.

18. The system of claim 16, wherein the shared computer vision neural network comprises:
an encoder neural network configured to process the input image to generate an encoded representation of the input image, and
an auto-regressive decoder neural network configured to auto-regressively generate the output sequence conditioned on the encoded representation of the input image and the prompt sequence.

19. The system of claim 18, wherein the prompt sequence is a sequence of tokens from the shared vocabulary, and wherein the auto-regressive decoder neural network is configured to, at each time step:
process an input sequence comprising (i) the prompt sequence and (ii) any tokens at any earlier time steps in the output sequence to generate a probability distribution over the tokens in the vocabulary.

20. The system of claim 18, wherein the auto-regressive decoder neural network is an auto-regressive self-attention decoder neural network.
